(19) United States
(12) Patent Application Publication
(10) Pub. No.: US 2024/0144164 A1
(43) Pub. Date: May 2, 2024

(54) METHOD FOR LOCALIZED PRODUCT DELIVERY ORDERING

(71) Applicant: AKiAKi Inc., Manor, TX (US)

(72) Inventors: Michael Brandon Calvin, Manor, TX (US); Devin Ernesto Simonson, Manor, TX (US); Aaron Benjamin Handwerker, Manor, TX (US)

(21) Appl. No.: 18/386,120

(22) Filed: Nov. 1, 2023

Related U.S. Application Data
(60) Provisional application No. 63/421,285, filed on Nov. 1, 2022.

(51) Int. Cl. G06Q 10/0834

(52) U.S. Cl. CPC G06Q 10/08345

(57) ABSTRACT

A method includes: receiving, from a buyer device associated with a buyer at a first merchant location, a check-in message including a duration of time the buyer is available to accept a delivery order at the first merchant location, a maximum delivery distance from the first merchant location the buyer will travel to complete a delivery order; generating an availability notification including a remaining amount of the duration of time the buyer is available to accept a delivery order at the first merchant location; in response to receiving a search query for the first merchant location from a customer device within the duration of time, transmitting the availability notification to the customer device; and, in response to receiving a first delivery order from the first customer device within the duration of time, generating a prompt, at the buyer device, including the first delivery order at the first merchant location.

### CROSS-REFERENCE TO RELATED APPLICATIONS

This application claims the benefit of U.S. Provisional Application No. 63/421,285, filed on 1 Nov. 2022, which is incorporated in its entirety by this reference.

### TECHNICAL FIELD

This invention relates generally to the field of product delivery and more specifically to a new and useful method for localized product delivery ordering in the field of product delivery.

### BRIEF DESCRIPTION OF THE FIGURES

FIG. 1 is a flowchart representation of a method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Methods

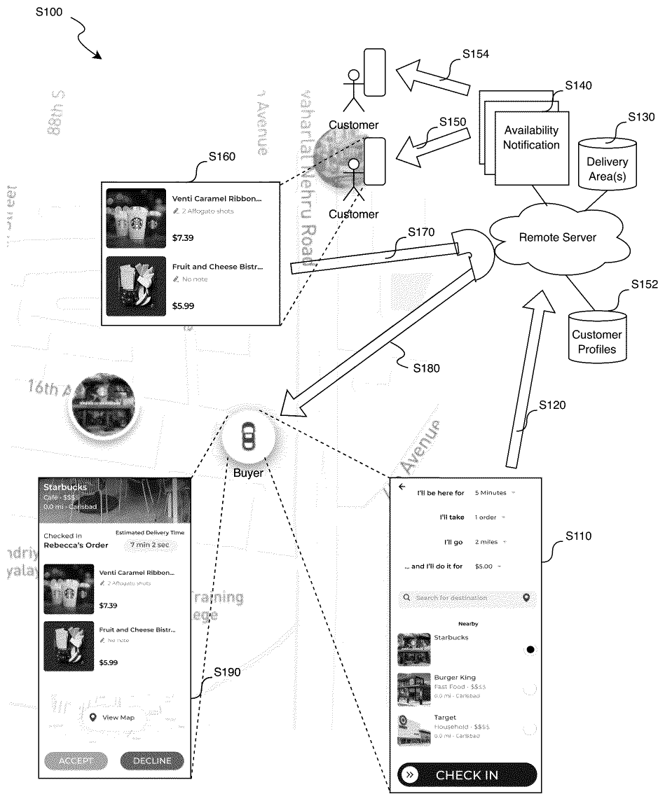

As shown in FIG. 1, a method S100 includes receiving, from a buyer device associated with a buyer at a first merchant location, a check-in message in Block S120, the check-in message including: a duration of time the buyer is available to accept a delivery order at the first merchant location from a customer; a maximum delivery distance from the first merchant location the buyer will travel to complete a delivery order; and a minimum fee the buyer will accept from a customer in exchange for completing a delivery order.

The method S100 also includes, in response to receiving the check-in message: calculating a delivery area based on the maximum delivery distance in Block S130; and generating an availability notification in Block S140. The availability notification includes: a remaining amount of the duration of time the buyer is available to accept a delivery order at the first merchant location; and the minimum fee.

The method S100 further includes, in response to receiving a search query for the first merchant location from a customer device within the duration of time, transmitting the availability notification to the customer device in Block S150.

The method S100 also includes, in response to receiving a first delivery order from the first customer device within the duration of time, generating a prompt at the buyer device in Block S190, the prompt including the first delivery order at the first merchant location.

### 2. Applications

Generally, Blocks of the method S100 can be executed by a computer system to: generate a check-in message from a buyer (e.g., operating a buyer device) at a merchant location (e.g., a retail store, a restaurant, a concession stand), the check-in message including a set of parameters defined by the buyer (e.g., a maximum distance the buyer is willing to travel to complete a delivery order, a minimum fee the buyer is willing to accept to complete the delivery order); notify customers (e.g., each operating a customer device), within a delivery area (e.g., based on the maximum distance defined by the buyer), of an availability of the buyer to accept delivery orders at the merchant location; and transmit a delivery order(s) from the customer(s) to the buyer while the buyer is available at the merchant location. Accordingly, the computer system can function as a localized product delivery ordering platform to leverage a buyer's proximity to a merchant location from which a customer wishes to place a delivery order, which reduces a total amount of time to complete the delivery order.

In one example, Blocks of the method S100 can be executed by a computer system to: generate a check-in message from the buyer device at the merchant location (or within a predefined proximity to the merchant location); notify a set of customer devices, within a delivery area, of an availability of the buyer to accept delivery orders at the merchant location based on customer profiles corresponding to the set of customer devices; and transmit delivery order(s) from the customer device(s) to the buyer device while the buyer is available at the merchant location. Accordingly, the computer system can proactively notify a customer who frequently orders from the merchant location or who frequently searches for a purchase product category offered at the merchant location of an available buyer to complete an order on behalf of the customer.

In another example, Blocks of the method S100 can be executed by a computer system to: generate check-in messages from a set of buyer devices at a set of merchant locations (e.g., a set of coffee shops); notify a customer device, within a delivery area, of availabilities of buyers to accept delivery orders at the set of merchant locations in response to a query from the customer device for a purchase product category (e.g., coffee) corresponding to the set of merchant locations; and transmit a delivery order from the customer device to the buyer device while the buyer is available at the merchant location. Accordingly, the computer system can match a customer searching for a particular purchase product category to available buyers located at merchant locations offering the desired purchase product category. Therefore, the computer system obviates a need for a customer to browse individual ordering platforms of each merchant, place a delivery order with a selected merchant, and wait for the selected merchant to dispatch a deliverer to complete the order.

### 3. Terminology

Generally, a “merchant location” as referred to herein is a physical retail location at which a sales transaction can occur.

Generally, a “customer” as referred to herein is a person who places a delivery order including one or more products from a merchant location.

Generally, a “buyer” as referred to herein is a person who completes a transaction for a delivery order at a merchant location on behalf of a customer and delivers the product(s) to the customer in exchange for a fee.

Generally, a “customer device” as referred to herein is a mobile device executing a customer application and is carried by or associated with a customer.

Generally, a “buyer device” as referred to herein is a mobile device executing a buyer application and is carried by or associated with a buyer.

Generally, a “remote server” as referred to herein is a remote computing system configured to receive and respond to requests and other communication from buyer devices and customer devices. A “remote server” can include one or more computing devices and, in one variation, one or more databases.

Generally, a “primary merchant location” as referred to herein is a merchant location: at which a buyer checks-in; and where a buyer is located or to which the buyer is traveling.

Generally, a “secondary merchant location” as referred to herein is a merchant location nearby a primary merchant location or near a route to a primary merchant location.

### 4. System

Blocks of the method S100 can be executed by a computer system, such as: locally on a mobile device(s) (e.g., smartphone, tablet, laptop, desktop computer, smart watch); or remotely at a remote server connected to a mobile device(s) via a network (e.g., the Internet).

The computer system can also interface with a user (e.g., a buyer, a customer) via a user portal, such as accessible through a web browser or a native application executing on a mobile device, to serve prompts and notifications to the user and to receive selections and/or input(s) from the user.

### 5. Buyer Check-In

Generally, in Block S110, a buyer device generates a check-in message indicating availability of a buyer to complete a delivery order at a merchant location on behalf of a customer.

In one implementation, the buyer device generates a prompt that allows the buyer to define a set of parameters including: a merchant location at which the buyer is available to accept a delivery order from a customer; a duration of time the buyer is available to accept a delivery order at the merchant location from a customer; a maximum number of delivery orders the buyer is accepting at the merchant location; a maximum distance from the merchant location the buyer will travel to complete a delivery order; and a minimum delivery fee the buyer will accept from a customer in exchange for completing a delivery order. In one variation, the set of parameters includes a maximum delivery time the buyer will travel to complete a delivery order.

In one implementation, the buyer device generates a check-in message including the set of parameters in Block S110 and transmits the check-in message to a remote server in Block S120.

In one variation, the buyer device can generate a check-in message indicating availability of the buyer to complete a delivery order at a given merchant location only when the buyer device is located within a predefined proximity (e.g., 1 mile, 5 miles) of the given merchant location. Additionally or alternatively, the buyer device can preemptively generate a check-in message prior to the buyer's arrival at the given merchant location. In another variation, the buyer device can preemptively generate a set of check-in messages corresponding to a set of merchant locations prior to the buyer's arrival at each merchant location (e.g., a set of merchant locations along a route).

### 5.1 Example: Real-Time at Merchant Location

In one example, Buyer A is located at Coffee Shop C and is available to accept delivery orders at Coffee Shop C. Buyer A's buyer device generates a prompt allowing Buyer A to define a set of parameters pertaining to the buyer's availability to accept delivery orders at Coffee Shop C. The buyer device receives Buyer A's input and generates a check-in message including the set of parameters specifying: Buyer A is available to accept delivery orders at Coffee Shop C; Buyer A is available to accept delivery orders at Coffee Shop C for the following five minutes; Buyer A is only accepting a single delivery order; Buyer A will travel a maximum of two miles to complete the delivery order; and Buyer A will accept a minimum of five dollars from a customer in exchange for completing the delivery order. The buyer device can then transmit the check-in message to a remote server.

### 5.2 Example: Preemptive at Merchant Location

In one example, Buyer B is en route to Coffee Shop C and estimates Buyer B will be available to accept delivery orders at Coffee Shop C until arrival in five minutes. Buyer B's buyer device generates a prompt allowing Buyer B to define a set of parameters pertaining to the Buyer B's availability to accept delivery orders at Coffee Shop C. The buyer device accepts Buyer B's entries and generates a check-in message including the set of parameters specifying: Buyer B is available to accept delivery orders at Coffee Shop C; Buyer B is available to accept delivery orders at Coffee Shop C for the following five minutes; Buyer B is only accepting a single delivery order; Buyer B will travel a maximum of two miles to complete the delivery order; and Buyer B will accept a minimum of five dollars from a customer in exchange for completing the delivery order. The buyer device then transmits the check-in message to a remote server.

### 6. Delivery Area

In one implementation, in Block S130, a remote server calculates a delivery area based on the maximum distance defined in the check-in message. In one example, the remote server can calculate the delivery area as a circle centered around the merchant location and exhibiting a radius equal to the maximum distance. In another example, the remote system can calculate the delivery area to include locations whose distance along routes from the merchant location are within the maximum distance.

In one variation, the remote server calculates a delivery area based on the maximum travel time defined in the check-in message. For example, the remote system can calculate the delivery area to include locations whose estimated travel time from the merchant location (e.g., based on mode of travel, based on speed limit, based on traffic conditions) is within the maximum travel time.

### 7. Customer Notification

Generally, a remote server can: generate an availability notification corresponding to a buyer's check-in message and indicating availability of the buyer to accept a delivery order at a merchant location in Block S140; and transmit the availability notification to a set of customer devices within the delivery area in Blocks S150 and S154. In one implementation, the remote server can generate the availability notification including: a merchant location at which the buyer is available to accept a delivery order from a customer; a remaining amount of time the buyer is available to accept a delivery order at the merchant location; a remaining number of delivery orders the buyer is accepting at the merchant location; and a minimum fee the buyer will accept from a customer in exchange for completing a delivery order.

Additionally, the remote server can generate the availability notification including other information about the buyer, such as a name, a profile picture, an indication the buyer is accepting a total of one delivery order at the merchant location, a total number of orders completed by the buyer, an average customer rating, an order accuracy metric, an order acceptance rate, and/or any other metric.

### 7.1 Customer Notification: Search

In one implementation, in Block S150, the remote server transmits the availability notification in response to receiving a search query for the merchant location from a customer device located within the delivery area. For example, the remote server can receive a search query including a name of a given merchant location from a customer device. The remote server can subsequently detect that the customer device is within a delivery area corresponding to a given buyer from which a check-in message has been received and is accepting a delivery order at the given merchant location. The remote server can the transmit, to the customer device, an availability notification corresponding to the given buyer.

In one variation, in Block S150, the remote server transmits the availability notification in response to receiving a search query, from a customer device located within the delivery area, for a purchase product category matching a purchase product category offered at the merchant location. For example, the remote server can receive a search query including a name of a product category (e.g., coffee, pizza, groceries) from a customer device. The remote server can subsequently detect that the customer device is within a delivery area corresponding to a given buyer from which a check-in message has been received and is accepting a delivery order at a merchant location (e.g., coffee shop, pizza restaurant, supermarket) that offers the purchase product category named in the search query. The remote server can then transmit, to the customer device, an availability notification corresponding to the given buyer.

In one implementation, the remote server transmits, to a customer device, a set of availability notifications matching a search query. In one example, in response to receiving a search query for a given merchant location, the remote server can transmit to a customer device a set of availability notifications corresponding to every buyer available to accept delivery orders at the given merchant location, the customer device located within respective delivery areas of each buyer. In another example, in response to receiving a search query for a given purchase product category, the remote server can transmit to a customer device a set of availability notifications corresponding to every buyer available to accept delivery orders at a set of merchant locations that offer the purchase product category indicated in the search query, the customer device located within respective delivery areas of each buyer.

### 7.1.1 Example: Merchant Location Name Search

Continuing the “Real-Time at Merchant Location” and “Preemptive at Merchant Location” examples discussed above, in response to receiving a search query for “Coffee Shop C” from Customer D's customer device, in response to detecting Buyer A and Buyer B are accepting delivery orders at Coffee Shop C, and in response to detecting Customer D's customer device is within respective delivery areas corresponding to Buyer A's check-in message and Buyer B's check-in message, the remote server transmits a first availability notification associated with Buyer A's check-in message and a second availability notification associated with Buyer B's check-in message to Customer D's customer device. Customer D's customer device can then generate a prompt(s) displaying the first availability notification and the second availability notification. In particular, Customer D's customer device can display respective sets of parameters included in the first availability notification and the second availability notification.

For example, Customer D's customer device can display a prompt indicating: Buyer A is available to accept delivery orders at Coffee Shop C for the following two minutes (i.e., there are two minutes remaining on the five minute duration of time Buyer A is available to accept a delivery order at Coffee Shop C); Buyer A is only accepting a single delivery order; and Buyer A will accept a minimum of five dollars from a customer in exchange for completing the delivery order. Similarly, Customer D's customer device can display a prompt indicating: Buyer B is available to accept delivery orders at Coffee Shop C for the following five minutes; Buyer B is only accepting a single delivery order; and Buyer B will accept a minimum of five dollars from a customer in exchange for completing the delivery order.

### 7.1.2 Example: Purchase Product Category Search

In one variation, in response to receiving a search query for “coffee” from Customer E's customer device, in response to detecting Buyer A and Buyer B are accepting delivery orders at Coffee Shop C, and in response to detecting Customer E's customer device is within respective delivery areas corresponding to Buyer A's check-in message and Buyer B's check-in message, the remote server transmits a first availability notification associated with Buyer A's check-in message and a second availability notification associated with Buyer B's check-in message to Customer E's customer device. The remote server can also transmit a third availability notification associated with Buyer F's check-in message indicating availability to accept delivery orders at Coffee Shop G in response to detecting Customer E's customer device is within a delivery area corresponding to Buyer E's check-in message.

Customer E's customer device can then generate a prompt(s) displaying the first availability notification, the second availability notification, and the third availability notification. In particular, Customer E's customer device can display respective sets of parameters included in the first availability notification, the second availability notification, and the third availability notification.

### 7.2 Customer Notification: Push

Generally, the remote server can: select a set of customer profiles corresponding to the availability notification in Block S152; and transmit the availability notification to a set of customer devices corresponding to the set of customer profiles in Block S154.

In one implementation, the remote server selects a customer profile based on: a current location of the customer being within a delivery area corresponding to a buyer's check-in message (e.g., within two miles of the merchant location, within ten minutes of travel from the merchant location); a current location of the customer being within a predefined proximity of the merchant location (e.g., within one mile); a frequency at which the customer is within a predefined proximity of the merchant location (e.g., at least once per week); a frequency at which the customer is located at the merchant location (e.g., at least once per month); a frequency at which the customer searches for the merchant location (e.g., at least once per week); a frequency at which the customer searches for a purchase product category offered by the merchant location (e.g., at least once per week); the customer's order history; and/or a history of availability notifications transmitted to the customer's customer device. The remote server can select a customer profile based on any metric or combination of metrics.

In one variation, the remote server can select a customer profile corresponding to a given customer based on customer configuration (e.g., opt-in to availability notifications, opt-out of availability notifications, snooze availability notifications for one hour).

### 7.2.1 Example: Push Notification

Continuing the “Real-Time at Merchant Location and “Preemptive at Merchant Location” examples discussed above, in response to detecting Customer H places a delivery order at Coffee Shop C once per week, in response to detecting Buyer A and Buyer B are accepting delivery orders at Coffee Shop C, and in response to detecting Customer H's customer device is within a delivery area corresponding to Buyer A's check-in message, the remote server transmits a first availability notification associated with Buyer A's check-in message to Customer H's customer device. Customer H's customer device can then generate a prompt(s) displaying the first availability notification. In particular, Customer H's customer device can display respective sets of parameters included in the first availability notification.

### 8. Customer Delivery Order

Generally, a customer device generates a delivery order based on an availability notification in Block S160 and transmits the delivery order to the remote server in Block 170. In particular, the customer device generates a prompt(s) displaying one or more availability notifications, and the customer device receives a selection, from the customer, of a buyer corresponding to a displayed availability notification with which the customer intends to place a delivery order. The customer device then generates a delivery order corresponding to the selected buyer and transmits the delivery order to the remote server.

In one implementation, the customer device generates a prompt that allows the customer to define a set of parameters for the delivery order including: a merchant location at which the customer is placing the delivery order; a product(s) to be purchased at the merchant location; a delivery address or location of the customer; a delivery fee to be paid in exchange for completing the delivery order; and a tip amount to be paid for completing the delivery order.

Additionally, the set of parameters for the delivery order can include a measure of urgency. In one example, the customer device can generate a prompt that allows the customer to specify: the delivery order must be completed within a defined amount of time (e.g., fifteen minutes); the delivery order must be completed before any other delivery orders can be accepted by the buyer; the delivery order must be the only delivery order accepted by the buyer; and/or any other condition or information.

The customer device then generates a delivery order including the set of parameters and transmits the delivery order to the remote server. In one variation, the customer device transmits the delivery order directly to the buyer device associated with the selected buyer.

### 8.1 Example 6: Delivery Order

Continuing the “Merchant Location Name Search” example discussed above, Customer D's customer device can receive selection of Buyer A to place a delivery order at Coffee Shop C. For example, Customer D may select Buyer A over Buyer B with whom to place a delivery order because Buyer B is available to accept delivery orders for three minutes longer than Buyer A; therefore, Buyer A may be more likely to complete Customer D's delivery order sooner than Buyer B (e.g., three minutes sooner).

Customer D's customer device can then generate a prompt allowing Customer D to define a set of parameters for the delivery order including: a product(s) to be purchased at Coffee Shop C (e.g., venti caramel latte, fruit and cheese snack box); a delivery address or location of Customer D; a delivery fee to be paid in exchange for completing the delivery order (e.g., five dollars); and a tip amount to be paid for completing the delivery order (e.g., two dollars). Customer D's customer device then generates the delivery order including the set of parameters and transmits the delivery order to the remote server.

### 9. Delivery Order Acceptance and Completion

Generally, in Block S180, a buyer device receives a delivery order and generates a prompt displaying the delivery order, including: a merchant location at which the customer is placing the delivery order; a product(s) to be purchased at the merchant location; a total price of product(s) to be purchased at the merchant location; a delivery address or location of the customer; a delivery fee to be paid in exchange for completing the delivery order; and a tip amount to be paid for completing the delivery order. In one variation, the buyer device can also generate the prompt displaying: a measure of urgency associated with the delivery order; a suggested route to travel from the merchant location to the delivery address of the customer; an estimated distance of the suggested route to travel from the merchant location to the delivery address of the customer; and/or an estimated travel time utilizing the suggested route from the merchant location to the delivery address of the customer (e.g., based on mode of travel, based on speed limit, based on traffic conditions).

In one implementation, the buyer device receives a selection, from the buyer, to accept or reject the delivery order. In response to receiving a selection to accept the delivery order, the buyer device transmits a confirmation of delivery order acceptance to the remote server (or to the customer device corresponding to the delivery order). Similarly, in response to receiving a selection to reject the delivery order, the buyer device transmits a notification of delivery order rejection to the remote server (or to the customer device corresponding to the delivery order).

In one implementation, a buyer device implements a virtual payment mechanism (e.g., virtual credit card) to complete the transaction for the accepted delivery order at the merchant location. The buyer device can then record and transmit an image of a purchase receipt to the remote server and/or the customer device. In response to receiving an indication that the delivery order is complete at the delivery address of the customer, the buyer device transmits a notification to the remote server and/or the customer device. The remote server subsequently deposits the delivery fee and the tip amount into an account associated with the buyer.

### 11. Secondary Merchant Locations

In one variation, a buyer device can receive a delivery order at a secondary merchant location for which a check-in message has not been generated. In particular, a buyer device can receive a selection from the buyer indicating: the buyer is available to accept delivery orders from a secondary merchant location(s); a duration of time the buyer is available to accept a delivery order at a secondary merchant location(s); a maximum number of delivery orders the buyer is accepting at a secondary merchant location(s); a maximum distance from a primary merchant location the buyer will travel to complete a delivery order at a secondary merchant location(s); a maximum distance from a route to one or more primary merchant locations the buyer will travel to complete a delivery order from a secondary merchant location; a minimum delivery fee the buyer will accept from a customer in exchange for completing a delivery order at a secondary merchant location; and/or maximum delivery time the buyer will travel to complete a delivery order at a secondary merchant location.

In one implementation, the buyer device can receive the selections as part of Block S110 when defining the set of parameters for a check-in message to a primary merchant location. Additionally or alternatively, the buyer device can receive the selections as a default configuration for a buyer profile corresponding to the buyer.

Generally, in Blocks S140, S150, S152, and S154, the remote server: generates a set of availability notifications based on the buyer's availability to accept delivery orders from secondary merchant locations; and transmits the set of availability notifications to a selected set of customer devices as described above. For example, the remote server can generate an availability notification for every secondary merchant location within the maximum distance, as defined by the buyer, from a primary merchant location.

### 11.1 Example: Secondary Merchant Locations

In one variation to the “Preemptive at Merchant Location” example discussed above, Buyer B is en route to Coffee Shop C and has previously indicated availability to accept delivery orders at secondary merchant locations. For example, Buyer B has previously indicated availability to accept delivery orders from secondary merchant locations within one hundred yards of Coffee Shop C and within one hundred feet of a route to Coffee Shop C. The remote server generates a set of availability notifications corresponding to a set of secondary merchant locations within one hundred yards of Coffee Shop C or within one hundred feet of a route to Coffee Shop C, including an availability notification corresponding to Ice Cream Parlor I.

The remote server transmits the availability notification corresponding to Ice Cream Parlor I in response to receiving a search query for “ice cream” from Customer J's customer device. Customer J's customer device generates and transmits a delivery order at Ice Cream Parlor I, which is received by Buyer B's buyer device and can be accepted or rejected by Buyer B.

### 12. Bounties

In one variation, in Block S160, a customer device generates a delivery order at a merchant location for which there is an absence of availability notifications and transmits the delivery order to the remote server. In particular, the customer device generates the delivery order to include an additional delivery fee to be paid in exchange for completion of the delivery order. In one implementation, the remote server broadcasts the delivery order to a set of buyer devices within a predefined distance of the merchant location (e.g., ten miles).

### 13. Hyper-Local Ordering

In another variation, Blocks of the method S100 can be implemented in a hyperlocal setting (e.g., venue, stadium, arena, amusement park).

For example, a buyer device can generate and transmit a check-in message including: a concession stand at which a buyer is available to accept delivery orders; a maximum amount of time the buyer will wait in line; a maximum distance from the concession stand the buyer will travel to complete the delivery order; a maximum distance from a particular seating section the buyer will travel to complete the delivery order; a maximum distance from a route between the concession stand and the particular seating section the buyer will travel to complete the delivery order; and/or a minimum delivery fee the buyer will accept from a customer in exchange for completing a delivery order at the concession stand.

In another example, in response to receiving a search query from a customer device including a seating section of the customer, the remote server transmits availability notifications corresponding to concession stands within a predefined proximity (e.g., one hundred yards) of the seating section of the customer. A delivery order can then be generated, accepted, and completed as described above.

### 14. Conclusion

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
receiving, from a buyer device associated with a buyer at a first merchant location, a check-in message comprising:
a duration of time the buyer is available to accept a delivery order at the first merchant location from a customer;
a maximum delivery distance from the first merchant location the buyer will travel to complete a delivery order; and
a minimum fee the buyer will accept from a customer in exchange for completing a delivery order;
in response to receiving the check-in message:
calculating a delivery area based on the maximum delivery distance; and
generating an availability notification comprising:
a remaining amount of the duration of time the buyer is available to accept a delivery order at the first merchant location; and
the minimum fee;
in response to receiving a search query for the first merchant location from a customer device within the duration of time, transmitting the availability notification to the customer device; and
in response to receiving a first delivery order from the first customer device within the duration of time, generating a prompt at the buyer device, the prompt comprising the first delivery order at the first merchant location.
